(19) United States
(12) Patent Application Publication
(10) Pub. No.: US 2010/0080693 A1
(43) Pub. Date: Apr. 1, 2010

(54) TURBOCHARGER

(75) Inventor: Alfred Grzonkowski, Mehlingen (DE)

Correspondence Address: BORGWARNER INC. C/O PATENT CENTRAL LLC, 1401 HOLLYWOOD BOULEVARD, HOLLYWOOD, FL, 33020-5237, US

(73) Assignee: BORGWARNER INC., Auburn Hills, MI (US)

(21) Appl. No.: 12/517,408

(22) PCT Filed: Oct. 23, 2007
(86) PCT No.: PCT/EP07/09191

§ 371 Date: Jun. 3, 2009

(30) Foreign Application Priority Data
Dec. 11, 2006 (DE) 10 2006 058 344.2

(51) Int. Cl. F02B 37/16

(52) U.S. Cl. 415/146

(57) ABSTRACT

The invention relates to a turbocharger (1) comprising a compressor (2) provided with a housing (3), an overrun air valve (4) provided with a valve housing (6) which is fixed to the compressor housing (3), and a boost pressure regulating valve (5). Said turbocharger is characterised in that the boost pressure regulating valve (5) is fixed to the valve housing (6) and connected in a pressurised manner to an internal pressure chamber (7) of the overrun air valve (4).

The invention relates to a turbocharger as per the preamble of claim 1.

A generic turbocharger is known from U.S. Pat. No. 6,205,784 B1.

In turbochargers of said type, the pressure regulating valve has hitherto been connected via a retaining plate with 3 hoses to the valve housing, and the electrical overrun air recirculation valve has hitherto been flange-mounted separately on the valve housing by means of screws. Said arrangement requires complex hose arrangements and increased assembly expenditure on account of the multiplicity of components. Furthermore, this results in increased susceptibility of the overall arrangement, or regulating circuits, to failure.

In contrast, it is an object of the present invention to create a turbocharger for an internal combustion engine as per the preamble of claim 1, which turbocharger has a simplified design and permits more economical projection of the charge pressure regulating valve and of the electrical overrun air recirculation valve.

Said object is achieved by means of the features of claim 1 or 2.

It is thus possible, in the design of the turbocharger according to the invention, for the charge pressure regulating valve to be seated on the electrical overrun air recirculation valve and to thereby produce a direct operative connection of said valve arrangement without a hose connection. It is therefore possible to create a simpler valve arrangement by connecting the overrun air recirculation valve and the charge pressure regulating valve (that is to say a combined overrun air recirculation valve and charge pressure regulating valve) and to reduce the number of components required in relation to the previous design.

The subclaims relate to advantageous refinements of the invention.

Claim 7 defines a valve arrangement according to the invention as a separately marketable object.

Claim 8 relates to an advantageous refinement of the valve arrangement according to claim 7.

Further details, advantages and features of the invention can be gathered from the following description of an exemplary embodiment and from the drawing, in which:

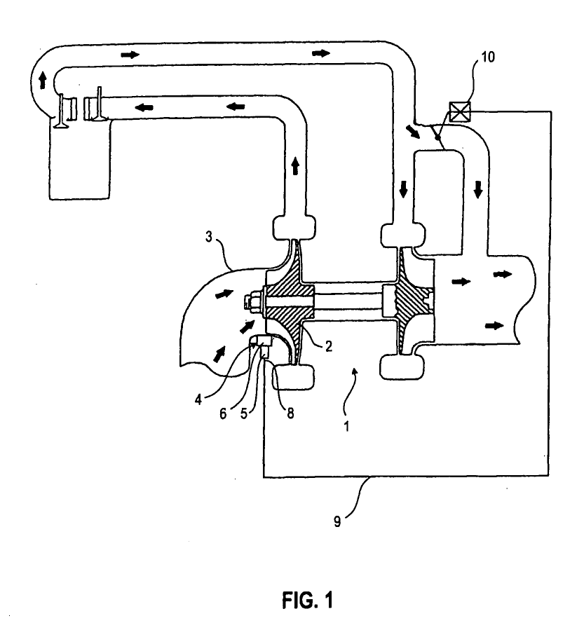

FIG. 1 shows a schematic illustration of the turbocharger arrangement according to the invention,

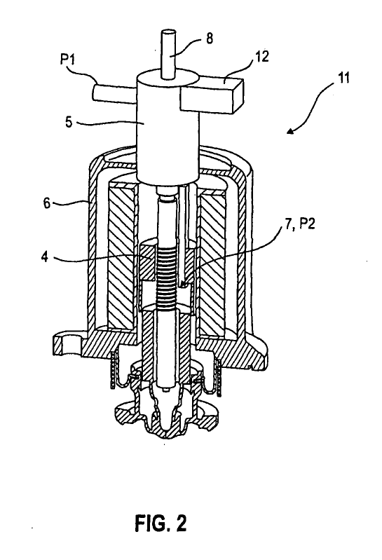

FIG. 2 shows a sectioned view through the charge pressure regulating valve which is connected to the overrun air recirculation valve, and

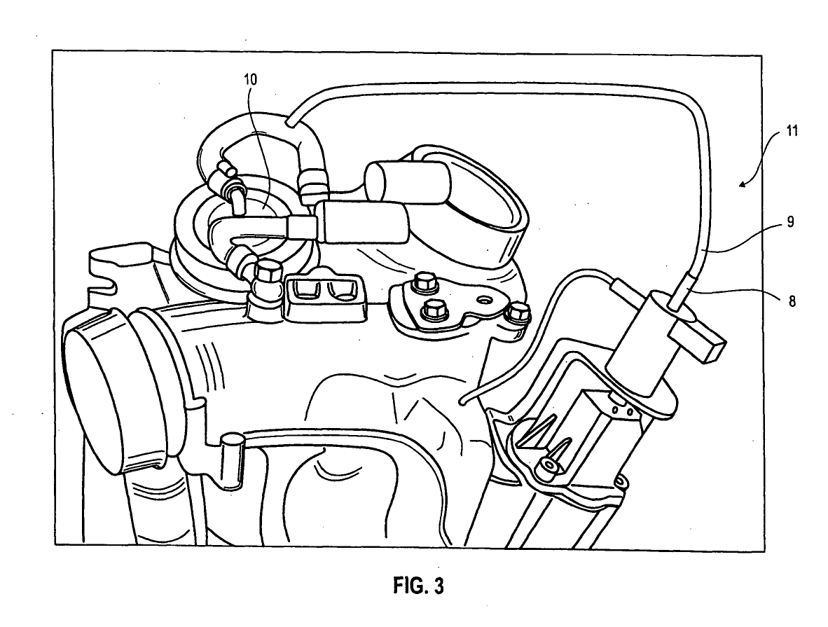

FIG. 3 shows a valve arrangement according to the invention in the assembled state.

FIG. 1 schematically illustrates a turbocharger arrangement 1 according to the invention.

The turbocharger 1 has a compressor 2 with a compressor housing 3. An overrun air recirculation valve 4 with a valve housing 6 is fastened to the compressor housing 3 of the compressor 2. A charge pressure regulating valve 5 is fastened to the valve housing 6 of the overrun air recirculation valve 4. An actuator output 8 of the charge pressure regulating valve 5 is connected by means of a hose connection 9 to an actuator 10.

All the other conventional components of the turbocharger arrangement 1 are not shown in any more detail here, since they are not of importance for the description of the invention.

FIG. 2 shows a diagrammatic illustration of the charge pressure regulating valve 5 which is connected to the overrun air recirculation valve 4. As can be seen from said FIG. 2, the charge pressure regulating valve 5, which has an actuator output 8, a connecting plug 12 for an electrical connection and an output P1, is placed onto the housing 6 of the overrun air recirculation valve 4. As a result of said arrangement, an operative connection of the compensated pressure P2, which prevails in an internal pressure chamber 7 of the electrical overrun air recirculation valve 4, to the charge pressure valve 5 is produced directly between said components without additional connecting elements, for example a hose connection. It may also be provided that the pressure port P1, which serves to ventilate the valve, runs within the valve housing and is directly connected to the compressor housing suction side without using a separate line.

FIG. 3 is an illustration of the compressor 2 with the valve arrangement 11 according to the invention. From said figure, it is possible to see the overrun air recirculation valve 4, which is connected directly to the charge pressure valve 5, and a hose connection 9 which leads to the actuator 10.

As a result of the valve arrangement 11, the number of components required is reduced at least by a hose with the associated hose clamps, and the bracket for the charge pressure regulating valve 5, which was hitherto fastened separately to the compressor housing 3, together with the associated fastening screws. This leads to reduced assembly and time expenditure during production, and to associated reduced costs. Furthermore, a further saving is possible in that the electrical connections of the charge pressure regulating valve and overrun air recirculation valve are combined to form one connection.

To complement the disclosure, reference is explicitly made to the diagrammatic illustration of the invention in FIGS. 1 to 3.

### LIST OF REFERENCE SYMBOLS

1 Turbocharger/exhaust-gas turbocharger
2 Compressor
3 Compressor housing
4 Overrun air recirculation valve
5 Charge pressure regulating valve
6 Valve housing
7 Internal pressure chamber
8 Actuator output
9 Hose connection
10 Actuator
11 Valve arrangement
P1 Pressure port
P2 Internal pressure, overrun air recirculation valve

1. A turbocharger (1)
having a compressor (2) which has a compressor housing (3),
having an overrun air recirculation valve (4) which has a valve housing (6) which is fastened to the compressor housing (3), and
having a charge pressure regulating valve (5),
wherein
the charge-pressure regulating valve (5) is fastened to the valve housing (6) and is connected in terms of pressure to an internal pressure chamber (7) of the valve housing (6) of the overrun air recirculation valve (4).

2. A turbocharger (1)
having a compressor (2) which has a compressor housing (3),
having an overrun air recirculation valve (4) which has a valve housing (6) which is fastened to the compressor housing (3), and
having a charge pressure regulating valve (5),
wherein
the charge-pressure regulating valve (5) is integrated in the valve housing (6) of the overrun air recirculation valve (4) for a pressure connection to an internal chamber (7) of the valve housing (6) of the overrun air recirculation valve (4).

3. The turbocharger as claimed in claim 1, wherein the charge pressure regulating valve (5) is provided with an actuator output (8).

4. The turbocharger as claimed in claim 3, wherein the actuator output (8) is operatively connected by means of a hose connection (9) to an actuator (10).

5. The turbocharger as claimed in claim 3, wherein the actuator output (8) is provided with a pressure port (P1).

6. The turbocharger as claimed in claim 5, wherein the pressure port (P1) is connected in terms of pressure by means of an opening, which is situated in the valve housing (6) of the overrun air recirculation valve (4), to an opening of the compressor housing (3).

7. A valve arrangement (11) of a turbocharger (1),
having an overrun air recirculation valve (4) which has a valve housing (6) which can be fixed to a compressor housing (3) of the turbocharger (1),
having a charge pressure regulating valve (5),
wherein
the charge pressure regulating valve (5) is fastened to the valve housing (6) and is connected in terms of pressure to an internal pressure chamber (7) of the valve housing (6) of the overrun air recirculation valve (4).

8. The valve arrangement as claimed in claim 7, wherein the overrun air recirculation valve (4) and the charge pressure regulating valve (5) are designed as a valve unit.
